(19) United States
(12) Patent Application Publication
(10) Pub. No.: US 2013/0097003 A1
(43) Pub. Date: Apr. 18, 2013

(54) COMPUTERIZED METHOD AND SYSTEM FOR ACCESSING MEDIA CONTENT OF A KNOWN PERSON

(71) Applicant: Aruze Studios California, LLC, Truckee, CA (US)

(72) Inventors: Anthony Baerlocher, Reno, NV (US); Paulina Rodgers, Reno, NV (US); Alexander Casey Naglestad Cohen, Los Alamitos, CA (US)

(73) Assignee: ARUZE STUDIOS CALIFORNIA, LLC, Truckee, CA (US)

(21) Appl. No.: 13/651,134

(22) Filed: Oct. 12, 2012

Related U.S. Application Data
(60) Provisional application No. 61/546,447, filed on Oct. 12, 2011.

(51) Int. Cl. G06Q 30/02

(52) U.S. Cl. 705/14.27

(57) ABSTRACT

An access system and method which provides a user the ability to purchase virtual stock in known persons in exchange for access to media content associated with the known person. The purchase of virtual stock by the user can be compared to virtual stock purchased by other users to determine each user's respective level of access granted them.

### CROSS-REFERENCE TO RELATED APPLICATION

This application claims priority to and the benefit of U.S. Provisional Patent Application Ser. No. 61/546,447, filed Oct. 12, 2011, the entire contents of which is incorporated herein by reference.

### TECHNICAL FIELD

Known persons, such as actors, musicians, athletes, authors, reality show participants, bloggers, professional game players, politicians, and other persons, some of who may have a heightened sensitivity to their rights of publicity, and/or a collection of such people (such as a team or musical band), often seek to maintain some sort of contact with their followers. Another word for known person is celebrity, and another word for follower is fan. Known persons can also include products, such as movies, songs, shows, websites, charities, or other such commercial or consumer offerings. It is contemplated that known persons can include any entity or subject matter that is currently able to have a Facebook® page, such as animals or even virtual persons. Typically though, due to the number of followers many of these known persons have, this contact is relegated to a fan club-style of arrangement, wherein followers sign up for 1-way communications coming from the known person. Additionally, and also primarily due to the large number of followers, the known person will simply provide a mass communication that will go out to every member of his fan club, without making any distinction between various members. The known person receives relatively little if any feedback or communications from these followers, other than perhaps a sum total of the number of current participants.

Even with the advent of the internet, the interaction between a known person and his followers is typically relegated to the known person posting on their blog, personal page, or sending out a short update on their current activities. But in response to such an action, the most the known person could expect to receive is an updated number of followers, or perhaps some unorganized comments from a minority of the followers. And the followers each have the same access to the posting, again without any distinction being made between the various followers. Further, known persons are providing their valuable time to update such current activities without any directly attributable financial benefit to themselves, which can also act as a disincentive to actively engage in further such updates.

From the follower's perspective, joining such a fan club style program provides minimal feedback or incentive to engage in the program. The follower might typically join a page of a known person shortly after that known person did something that garnered heightened interest from the follower, such as starring in a blockbuster movie or releasing a new album, etc., and at that point the follower is excited to follow the activities of the known person. However, this interest likely weans as the follower receives no perceived value in actively following such a program for the most recent updates.

While this method of following a known person is currently considered acceptable and even beneficial, it is believed by the applicant that creating a more interactive method of following a known person would provide increased benefits to both the known person and the followers.

### SUMMARY

The methods and systems disclosed herein provide for a novel way for known persons and their followers to interact. In one embodiment, a follower purchases virtual shares of a known person. In another embodiment, a follower is allowed to purchase various different classes of virtual shares of a known person. In still another embodiment, a follower is allowed to purchase various different classes of virtual shares by utilizing different classes of virtual currencies. In another embodiment, the known person will provide select media content to specific shareholders, which could depend on the number of shares a shareholder has, the number of a specific class of shares a shareholder might have, when the virtual shares were purchased by a shareholder, the rank of the shareholder in comparison to other shareholders, the percentage of outstanding shares the shareholder owns, combinations thereof, and other filtering methods as contemplated herein. In one embodiment, the follower uses their purchased virtual shares to play a simulated stock market game.

In one embodiment, the known person can gain invaluable information from his followers. Such information may include the demographics of the followers combined with their level of financial commitment to the known person. This may be accomplished by parsing out the associated information such as age, gender, locale of each of the followers against the details of their virtual share purchases and holdings. Such information could help a known person to choose particular jobs, or employers to offer particular jobs to the known person.

An example of such a benefit could be that an actor has 500,000 unique female shareholders aged 20 to 25, with an average holding of 10 shares each. However, that same actor has 150,000 unique male shareholders aged 40 to 45, with an average holding of 200 shares. Under prior fan club style programs, this actor may at most only have the baseline information of the number of followers that person has in each demographic, and thereby might prize a movie geared towards women aged 20 to 25 as this would appear to be his biggest fan base. However, when incorporating data which signifies the level of commitment a follower or group of followers has, such as total holdings or total value of holdings, the actor may realize that accepting a movie geared towards men aged 40 to 45 may actually result in higher financial gain as this demographic appears to be more willing to financially back their support of this actor. In this example, it also becomes evident that a movie studio or other potential employer would also find value in obtaining such detailed information, and it is contemplated that such an entity would provide separate consideration in order to obtain related information.

In one embodiment of the present disclosure, a computerized system is configured to allow a first user to purchase virtual shares in a known person, and obtain digital rights access to first media content associated with that known person. In another embodiment, the computerized system is further configured to allow a second user to purchase a different quantity of virtual shares in the known person, and grant digital rights access to different second media content associated with the known person. In still another embodiment, the digital rights access granted to each of the first and second users is based at least in part on a separate star point balance respectively associated with each of the first and second user. In a further embodiment, the computerized system is configured to automatically decrement the star point balance associated with a user based on operator-defined criteria.

It is therefore an advantage of the present disclosure to provide an interactive tool to allow known persons to interact with their followers.

It is another advantage of the present disclosure to allow people to actively follow a known person and take a monetary position on such activity.

It is a further advantage of the present disclosure to provide a tool so that a known person can determine value and information from his followers.

It is similarly an advantage of the present disclosure to provide a tool so that third parties can determine the value a known person might have with a grouping of followers.

It is another advantage of the present disclosure to provide an entertaining method to keep followers actively engaged in following a known person.

It is a further advantage to provide an entertaining game and/or competition.

It is still another advantage of the present disclosure to provide a system that allows a known person to derive financial benefit for actively engaging with their followers.

It should be understood that various changes and modifications to the presently preferred embodiments described herein will be apparent to those skilled in the art. Such changes and modifications can be made without departing from the spirit and scope of the present subject matter and without diminishing its intended advantages.

### BRIEF DESCRIPTION OF THE FIGURES

FIG. 1 is a schematic drawing illustrating how a system, in accordance with an embodiment of the present invention, would be configured.

FIG. 2 is a flowchart illustrating how a system, in accordance with an embodiment of the present invention, would be configured to allow access to a user.

FIG. 3 is a simplified version of how a computer-generated interface to the system, in accordance with an embodiment of the present invention, may be displayed.

FIG. 4 is a simplified version of how a computer-generated interface to a Celebrity Page, in accordance with an embodiment of the present invention, may be displayed.

FIG. 5 is a simplified version of how a computer-generated interface to a Celebrity Page, where multiple classes of virtual stock are offered, and in accordance with an embodiment of the present invention, may be displayed.

FIG. 5A is a table providing an example of how additional access criterion may be implemented in accordance with one embodiment of the present invention.

FIG. 6 is an exemplary interface to a system component that allows users to earn virtual dollars.

### DETAILED DESCRIPTION

A method, system, and computer-readable medium are described below which facilitates interactive relationships between a known person and his followers. In particular, in some embodiments disclosed herein, a website is provided which allows followers of a known person to purchase access to media content related to that known person. In a further embodiment, the purchased access is in the form of virtual stock of that known person, and the details of the stock purchase determines, at least in part, the level of access that is provided to the follower. In another embodiment, the purchased virtual stock provide the basis of a game played by the various followers, which creates additional incentive to purchase such stock.

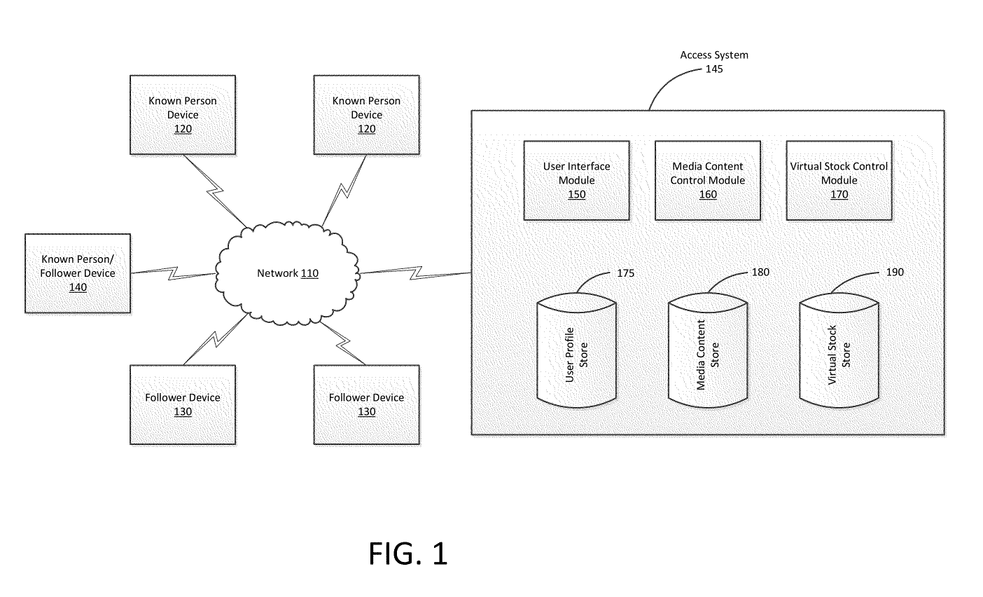

Referring to FIG. 1, a high-level schematic is shown of how a system, in accordance with one embodiment of the present invention, might be configured. Specifically, one or more known person devices 120 would communicate over a network 110 with an access system 145. Additionally, one or more follower devices 130 would communicate over a network 110 with the access system 145. It is also presently contemplated that a known person/follower device 140, which allows a known person to also act as a follower, would communicate over a network 110 with the access system 145.

The various devices 120, 130, and 140 could comprise desktop computers, laptop computers, tablet computers, e-readers, mobile/smart phones, gaming devices, personal digital assistants (pda's), televisions, and other network-enabled media display devices. Network 110 could comprise the internet or other similar area networks, and communication with various devices 120, 130 and 140 could be through a wireless or hardwire connection, or a mixture thereof. Only two follower devices 130, two known person devices 120, and a single known person/follower device 140 are shown in FIG. 1 in order to simplify and clarify the description, but it is contemplated that thousands or more of such devices could be communicating over the network 110 with the access system 145. Further, in one embodiment, there could be multiple access systems 145 in communication with each other and working together to provide the functionality of an access system 145 as described herein.

FIG. 1 contains a block diagram of the access system 145, according to one possible embodiment. Access system 145 comprises a computer system that allows users to communicate or otherwise interact with each other and access content as described herein. In this embodiment, the access system 145 includes a user interface module 150, a media module 160, a virtual stock control module 170, a user profile store 175, a media content store 180, and a virtual stock store 190. In other embodiments, the access system 145 may include additional, fewer, or different modules for various applications. Conventional components such as network interfaces, security mechanisms, load balancers, failover servers, management and network operations consoles, and the like are not shown so as to not obscure the details of the system, but are contemplated as possible additional components of the access system 145.

The user interface module 150 provides, or causes to be provided, a user interface between access system 145 and one of the devices 120, 130 or 140. The user interface can be any type of user interface, such as a graphical user interface (GUI) or a web-based user interface (WUI). Such a user interface allows a user to register, login, purchase virtual shares, access media content, and otherwise interface with the access system 145.

The media content module 160 acts as a gateway between the various users of the access system 145 and the media content store 180. The media content store 180 stores the various media content posted by the known persons or other users, described in more detail below, and the media content control module 160 facilitates access control to the stored media content. In one embodiment of the present invention, the media content control module 160 manages the process by which a known person may post media content to the media content store 180 by ensuring that the media content was properly loaded, stored and catalogued. In another embodiment, the media content control module 160 determines access to specific media content by at least first determining the virtual shareholdings of a follower, and then determining if such virtual shareholdings are sufficient to then grant access to the specific stored media. The media content store 180 could store various forms of media content, including but not limited to, pictures, written posts, video clips, links to website, sound recordings, animations, and combinations and variations thereof. Such media content could be posted by a known person, an agent for known person, the operator of the access system 145, or by a third party.

The virtual stock control module 170 controls the trading of virtual stocks by various users. The virtual stock control module 170 interacts with the virtual stock store 190, which stores information related to the various virtual shares and their associated details. Such details could include the associated known person, the specific class or type of share, the current share price, the number of outstanding shares, associated share transaction data, and other such details as might typically be associated with real-world share transactions. The virtual stock control module 170 then utilizes this data to manage requests made by followers to trade various virtual stocks. In one embodiment, a follower would utilize a follower device 130 to communicate over the network 110 a request to the access system 145 to purchase a lot of virtual shares, and such request would be routed through the virtual stock control module 170, which would utilize information obtained from the virtual stock store 190 to determine the details associated with granting such a request. The virtual stock control module 170 would then cause the access system 145 to communicate back to the follower device 130 and confirm the status of the request (e.g. granting or denying the request), and communicate with the virtual stock store 190 to log the requested transaction and final status.

The access system 145 stores user profiles in the user profile store 175. Profiles contain information about users of the access system 145, such as biographic, demographic, work experience, educational history, hobbies or interests, location, achievements, purchase information and history, and the like. It is to be understood that the user could be a known person or a follower (as defined herein), as both groups are users of the access system 145. The user profile store 175 interacts with the user interface module 150 to create new profiles when a new user registers with the access system for the first time, and to confirm existing profiles when a user accesses the access system 145 on subsequent occasions.

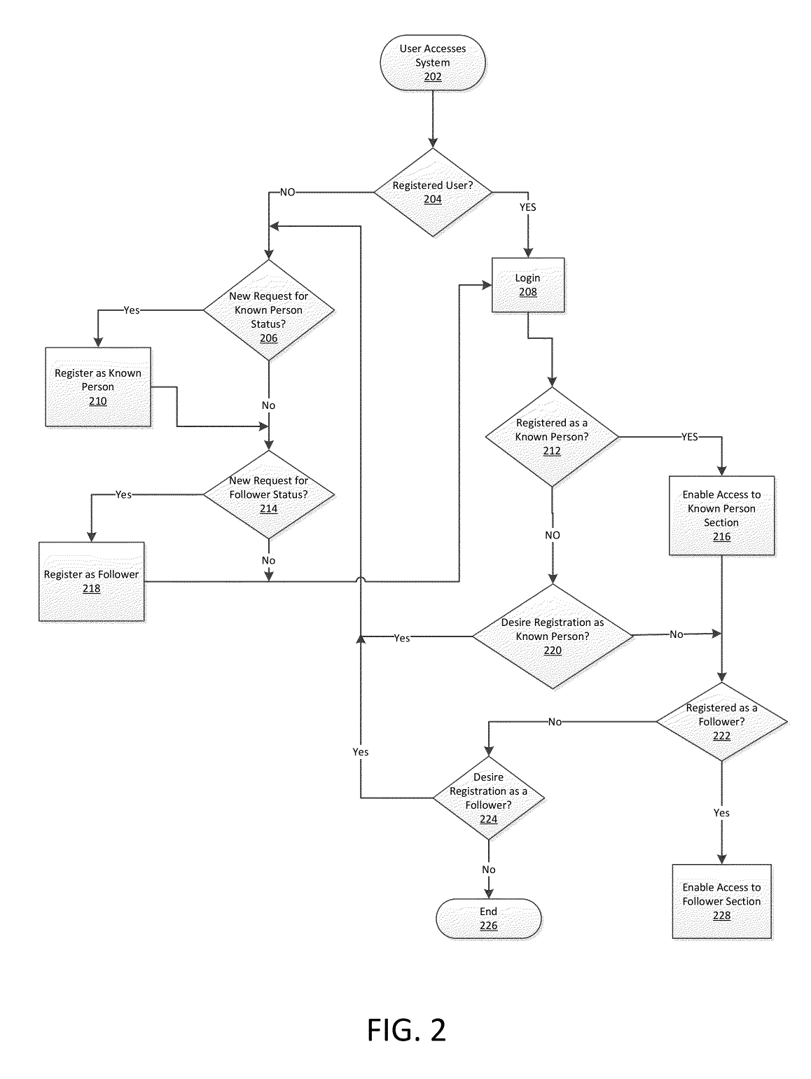

Referring to FIG. 2, the process by which a user would obtain access to access system 145 in one embodiment of the present invention will be discussed. At step 202, a user accesses the system. Again, it is contemplated that such access occurs via a device 120, 130 or 140 over a network 110. At step 204, the system causes the user to determine if they are a registered user. In one example, the system prompts the user to login or register as a new user, and this simple prompt can cause the user to determine if they are a registered user.

If the user is not a registered user, the system then determines if the user requests a known person status at step 206. If the user does request a known person status, then the system allows the user to register as a known person at step 210. Once the user has registered as a known person, or if the user does not request known person status, the system determines if the user requests a follower status at step 214. If the user does request a follower status, the system allows the user to register as a follower at step 218. Through this process of registering a new user, or if the user was determined by the system to be a registered user at step 204, the system allows the user to login at step 208. Again, in one embodiment, the simple act of a user logging in acts to also determine if the user is a registered user, and these steps may not necessarily be separate steps.

Once a user has logged in at step 208, the system determines if the user is registered as a known person at step 212. If the user is registered as a known person, the system enables access to the known person section of the system at step 216. If the user is not registered as a known person, the system provides a mechanism for the user to determine if they would like to register as a known person at step 220, and then directs the user back through the process at step 206. If the user has access to the known person section of the system or does not desire such registration, the system determines if the user is registered as a follower at step 222. If the user is registered as a follower, then the system enables access to the follower section of the system at step 228. If the user is not registered as a follower, the system provides a mechanism to determine if the user desires to be registered as a follower at step 224. If the user does desire to be registered as a follower, the system directs the user back through the registration steps of the process beginning at step 206. If the user does not desire to register as a follower, this process ends at step 226 simply because the system has already granted access to those sections the user has registered for.

It should be understood that the example process illustrated in FIG. 2 is not intended to provide the only way to determine the access granted to a user, but rather is simply an example of one possible way to implement such a process. For example, the determining of whether a user is registered as a known person at step 212 and determining if a user is registered as a follower at step 222 can be reordered or combined without substantively affecting the results of such a system. It is contemplated that there are several methods by which the operator of the user system could implement a process to determine access for both new and returning users without departing from the spirit and scope of the present invention, and FIG. 2 merely provides one example of such a process.

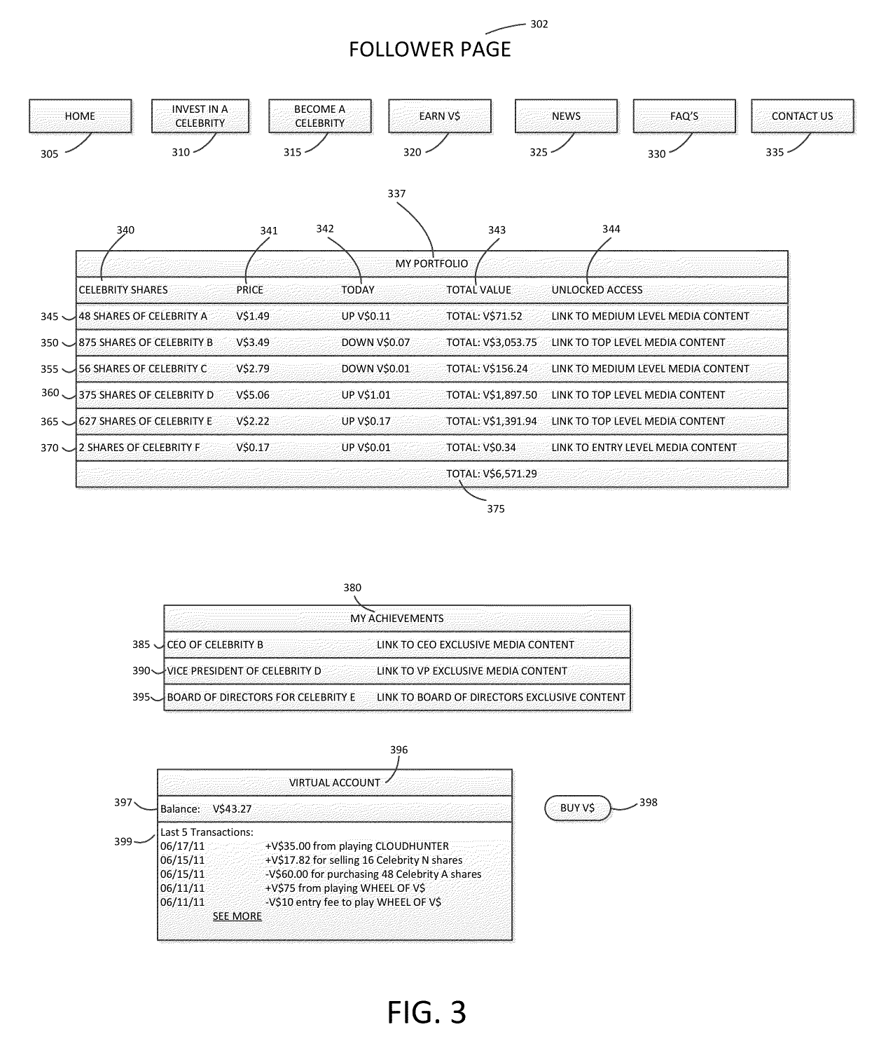

Referring to FIG. 3, a description of how an interactive game will be provided in accordance with one embodiment of the present invention will be discussed. FIG. 3 provides a simplified example of a Follower Page 302, which in one example is how an interface to the follower section of access system 145 may be displayed to a follower. Specifically, Home button 305 allows the follower to return to a home page of the access system 145. Invest in a Celebrity button 310 would take the follower to another interface which would allow the follower to research and trade in virtual stock in a celebrity. Become a Celebrity button 315 would take the follower to the registration template interface for a known person, as might be utilized at step 210 from FIG. 2. The Earn V$ button 320 would take the follower to an interface that would allow the follower to compete in other contests and games, or complete specified tasks, in an effort to earn additional virtual dollars, which could then be utilized to purchase additional virtual shares of a celebrity. As contemplated herein, there are several methods to earn or otherwise obtain virtual dollars, and several methods in which to utilize such virtual dollars. The News button 325 provides a link to an interface that contains news on the management of the access system 145. The FAQ's button 330 provides a link to an interface which provides common questions and answers on how to navigate through the access system 145. And the Contact Us button 335 provides an interface to contacting the management of the access system 145. As is readily apparent, fewer or more buttons could be provided without departing from the spirit or scope of the present invention.

A portfolio summary 337 could also be provided. Such a summary could have various information about the virtual shares acquired by the particular follower, such as the number and/or type of celebrity shares owned 340, the current price of those virtual shares 341, the daily movement of the price of the virtual shares 342, the total value of the shares for each holding 343 and cumulatively 375, and links to the unlocked media content 344 that has been provided in exchange for the purchase of the various virtual shares.

While the term “shares” is used in describing what a follower is purchasing in order to gain access to media content posted by a known person, it is contemplated that these shares are merely virtual shares, and that a purchaser of such virtual shares does not obtain any legal ownership rights to the known person, or any of the known person's assets. In one embodiment, the shares are merely a form of creating an entertaining game, which in turn provides a way to engage the followers and keep their attention on actively interacting with the known person. In one embodiment, it is contemplated that while a follower may be required to pay a monetary sum in order to purchase virtual shares, that the follower will not be able to receive a monetary sum upon selling their virtual shares. Rather, if a follower were to sell their virtual shares, they would merely receive virtual dollars (V$) with which they can then opt to purchase other virtual shares with, but which may not be exchanged for a true monetary sum. It is also contemplated that in one embodiment, a follower may purchase different classes of shares of a known person. In one such embodiment, a follower may utilize a relatively low amount of V$ to purchase class B shares, but must utilize a much higher amount of V$ in order to purchase class A shares. In another embodiment, in order for the follower to obtain the higher amount of V$ in order to purchase class A shares, the follower might exchange a monetary sum of money for the V$. In one embodiment, it is contemplated that there is a limit or cap on the level of access that class B shares could provide, and that in order to obtain the broadest access to the media content provided for a known person, the follower must purchase at least some number of class A shares.

In one embodiment, portions of a follower's portfolio of virtual shares will automatically expire based on an operator-configured algorithm. It is contemplated that by having shares expire or otherwise removed, that it will create a more dynamic market for the associated known persons, and that such a dynamic market will increase user entertainment. In one example of such an embodiment, a follower's portfolio for a known person may automatically diminish by 10% every two weeks. Such a reduction may result in the elimination of an achievement that particular follower had obtained related to that celebrity (e.g. by reducing the follower's total shareholding below a certain requisite level or below a level of another follower), and therefore create incentive for the follower to purchase additional, new virtual shares of the celebrity. In one embodiment, the algorithm to determine the rate of share expiration is based on one or more of time, total shareholdings of the follower, total outstanding shares related to the known person, current share purchasing activity related to the known person, historical share purchasing activity related to the known person, the follower's activity in relation to the access system, the known person's activity in relation to the access system, share price, or other measurable access system activity.

Continuing with FIG. 3, an example of a fictional portfolio will be examined. In this example, the follower has holdings in 6 celebrities, as shown at rows 345, 350, 355, 360, 365 and 370. Cross-referencing these rows with the headings 340, 341, 342, 343 and 344 provides substantial information on each particular holding. Additionally, a sum total 375 of all holdings may be provided to the follower. As is evident, each holding may have its own unique characteristics such as price 341, or it could have one of a distinct number of possible characteristics, such as the level of unlocked access 344. In this example, the level of holdings determines the level of media access, and specifically, the higher the holdings of a particular celebrity, the higher the level of media access. In this example, this is illustrated in the holdings of celebrity F at 370 which only provides a link to entry level media content, while the holdings of celebrity A 345 provides a link to medium level media content, but the holdings of celebrity B 350 provides a link to top level media content. Again, while this example relies on shareholdings to determine the level of unlocked access, it is contemplated that the level of access could be determined by the total number of shares purchased, the level of shareholdings compared to other shareholders, the number of various classes of shares owned, the percentage of change your shareholdings have had, the performance of your shares relative to other shareholders, any combination thereof, and any other manner in which an operator might want to distinguish between various shareholders. It is also contemplated that in one embodiment, while some of the unlocked access has the same titles (e.g. “LINK TO TOP LEVEL MEDIA CONTENT”), that the underlying unlocked media content will be necessarily different as the celebrity associated with the media content will be different. In one embodiment, different levels of unlocked media content will have standardized minimum requirements. An example of such standardization is that media content posted for the executive media content link must include a video of the celebrity, or must be of a certain length. In one embodiment, there are no minimum requirements for posted media content. It is contemplated that while some standardization is desired, ultimately it is in the benefit of the celebrity to create a market for their associated virtual shares, and that providing the incentive for such share purchases will likely require distinctive media content which will then be unlocked.

Additional information which could be provided on a follower interface might be an achievement summary 380, which identifies the various achievements a particular follower has obtained through their shareholdings. In the example shown in FIG. 3, this follower has achieved three separate achievements as shown at 385, 390 and 395. Specifically, the follower has obtained the title of CEO for his investments in celebrity B as shown at 385, Vice President for his investments in celebrity D as shown at 390, and is a member of the board of directors for his investments in celebrity E as shown at 395. In one embodiment, achieving a particular title unlocks additional media access as also indicated at 385, 390 and 395. In another embodiment, such achievements are obtained by comparing the follower's stockholdings of a particular celebrity to those of other follower's. For example, the overall top shareholder of a particular celebrity could be awarded with the title of the Chairmen of the Board, or the owner of the best performing portfolio of a particular celebrity (e.g., they have the highest return on their purchases of a particular celebrity) could be awarded the title of CFO. In another embodiment, achievement levels are delineated by a mixture of preset criteria and dynamic criteria. In one example of such an embodiment, the top ten shareholders of a certain stock may be provided access to a first level of access, and then the remaining top 20% of shareholders will be provided access to a second level of access. In such an example, it is evident that the system operator has significant flexibility to determine what activity constitutes enough activity to unlock associated media content. In one embodiment, the operator of the access system determines the criteria for various achievements. In another embodiment, the celebrity determines at least a portion of the criteria for the various achievements. In one embodiment, the criteria for various achievements are predetermined. In another embodiment, the criteria are dynamic. In a further embodiment, the criterion are reflexive and utilizes overall shareholdings of the known person and recent activity related to the virtual stock, such as purchases, sales, offers to purchase, offers to sell, share price, or other recent activity. In one embodiment, the known person is also subject to criteria in order to post media content. In one such example, the known person is required to populate a specific achievement level with media content before they are allowed to populate other achievement levels with media content. In this example, it is contemplated that requiring the known person to meet such criterion, it will help insure that the known person provides content to all or at least a desired number of achievement levels. Such a method can be utilized to act as a gatekeeper to allowing the known person to post media content to higher achievement levels, or to lower achievement levels, as desired by the system provider. As is apparent, there are many ways such criteria could be defined or modified without departing from the scope or spirit of the invention.

Continuing with the example of FIG. 3, the interface may include a summary of the follower's Virtual Account 396 which identifies the follower's V$ balance 397. Such a summary may also include a highlight of the follower's recent transactions 399. Additionally, a button to buy additional V$ 398 could provide the follower the opportunity to increase their V$ balance 397. It is contemplated that if the user were to click or otherwise select such a button or option, that they would be provided with an interface that would allow them to purchase, for monetary consideration, additional V$. In one embodiment, a follower can use their credit card, PayPal account, mobile phone account, money order, gift card, pre-paid account, or other form of monetary consideration to purchase V$ at an exchange rate established by the operator of the access system. Additionally, and as discussed above and below, a user can earn V$ through their investing in known persons or by participating in other contests or promotions provided by the operator of the system.

While not shown, in one embodiment Follower Page 302 provides the follower the opportunity to post media content. In this embodiment, the follower is thereby allowed to customize their page to their liking. In another embodiment, a follower can share their posted media content with other users of the access system. In one embodiment, a follower can customize their page with portions of the media content that they have been granted access to through their virtual share purchases. In another embodiment, a follower can allow other users to access their follower page.

It is contemplated that in one embodiment of the present invention, the combination of unlocking distinct levels of celebrity media content based on shareholdings, and identifying the various top shareholders with various titles, work together to create a strong demand to drive virtual share purchases. Specifically, some followers will want to purchase more shares in order to gain additional access to the media content posted by a particular known person, while other followers will want the recognition that comes from obtaining a title associated with having a top portfolio associated with that known person. It is contemplated that the situation that is created when one follower obtains, through associated share purchasing activity, a certain title associated with a known person which in turn removes or bumps another follower who previously held that certain title from that certain title, that the bumped follower will then have incentive to increase their share purchasing activity in an effort to retake or re-obtain that certain title. In such an example, the competition that is created is not dissimilar to the frenzy that can be created in a live auction setting, and the outcome can ultimately provide a very entertaining activity for the associated followers. It is also contemplated that many followers will find incentive in participating from the virtual stock market aspect of the present disclosure. Specifically, it is contemplated that many followers will endeavor to obtain the best performing virtual share portfolio, and in such instances, the unlocked access to media content provides additional incentive to participate is such a program.

This virtual stock market aspect of the present disclosure provides an additional game in which users can participate. However, such a game provides the additional benefit of allowing access to media content posted by the known persons the user is purchasing stock in. It is contemplated that this combination creates a unique dynamic that will provide incentive to both the follower and the known person to continue to actively interact with the access system. Such a game can be supplemented with leaderboards, which could identify the top performers locally, nationally, and globally, which again would provide incentive for some users to more actively participate. In one embodiment, leaders, as identified on a leaderboard, will be awarded bonuses. Examples of such bonuses can include additional attempts to win or achieve virtual dollars, the awarding of a preset amount of virtual dollars, access to additional media content, entry into tournaments, physical prizes, monetary prizes, gift certificates, or any other prize that a user may find value in obtaining. Such leaderboards can be displayed on a dedicated web page, or can be displayed on the interface to the associated follower or user. In one embodiment, leaderboards are provided for the known persons, and may rank such attributes as the total value of virtual shares of known persons held by followers, the activity level of various known persons as it relates to posting media content, or any other measurable activity related to the various known persons. In such an embodiment, the total value of a known person can be determined by the number of outstanding shares multiplied by their purchase price, the number of outstanding shares multiplied by their current trading price, or simply the current stock price for the known person. In one embodiment, leaderboards for the followers can rank such measurables as total portfolio value, total portfolio increase over a selected period of time, either on a percentage basis or total value basis, number of celebrity achievements held, either currently or historically, or any other measurable activity related to the follower's activities.

There are many ways to determine the stock price for a particular celebrity, and the daily changes thereto. In one embodiment, the stock prices reflect true market effects, and the price increases if demand is high, or the price declines if the demand is low. In another embodiment, the market effects of a particular virtual stock are supplemented with a predetermined algorithm in an effort to assist the situations where the buy/sell activity related to a particular virtual stock are not in balance, and therefore the stock price would not reflect the true market demand. In another embodiment, stock prices automatically increase based on the total number of purchases. In such an embodiment, for example, the first one hundred shares could sell for V$1.00 each, then the next one hundred shares automatically increase to V$1.05 each, and so on based on a preset table or algorithm. In one embodiment, virtual share transactions can be batched in a time-based manner, such as every hour or every day, etc., in an effort to help mitigate large or abnormal transaction activity from quickly or unfairly skewing associated virtual share prices. It is contemplated that by time-batching such transactions, the net effect of transactions occurring over that time period, in addition to delaying the immediate impact of the various transactions, will soften the effect that a single large transaction may have on a relatively lightly traded virtual stock. In another embodiment, share prices may be set to automatically decline based on inactivity or low activity in trader action. In such an example, if the shares of celebrity x have not been purchased or sold for a certain timeframe, the access system may cause the share price to automatically drop V$0.01 for each day that a trade is not executed related to that virtual share. In one embodiment, a random factor is utilized in conjunction with other methods as disclosed herein, to provide a more dynamic movement to associated stock prices. It is contemplated that such a dynamic factor would also provide additional security against unnecessary stock price manipulations by users of the system. In one example, the random factor is a random normally-distributed variable with a mean equal to the net number of shares transacted in each of several time-batched segments, as discussed above. In still another embodiment, the number of unique shareholders is used to determine a factor of the share price. In a further embodiment, the operator could unilaterally decide to adjust the virtual stock price up and down. In an example of such an embodiment, the operator may determine that a recent arrest of a known person should cause the virtual stock price associated with the known person down, and so implements a 10% decrease. It should be understood that there are many possible factors that may cause an operator to implement a stock change. In another embodiment, the operator of the access system acts as the only trading partner for any of the followers. In such an example, a follower can then only purchase shares from, or sell shares to, the operator, and there are no transactions between distinct followers allowed. In a further embodiment, followers are allowed to establish their own market for virtual shares, and may therefore buy and sell directly to each other. It is contemplated that in one example of such an embodiment, the involved followers would then simply notify the operator of the system that such a transaction transpired so as to properly account for current portfolio holdings of each of the followers.

In one embodiment, stock analysts could be utilized to affect the share price of a virtual share. In one example of such an embodiment, the stock analysis could provide recommendations such as an “upgrade” or “downgrade” a certain stock, based on various criteria, and such recommendations could then directly influence the share price, and/or could influence what holders of the shares do with the shares (e.g. hold, buy, sell) which in turn could influence the price of the shares. In one embodiment, the stock analyst is a real person. In another embodiment, the stock analyst is a virtual person who utilizes an artificial intelligence, or other algorithm to determine recommendations. In one contemplated embodiment, the analyst utilizes real-world data associated with the celebrity to determine recommendations. In another embodiment, the analyst utilizes a form of randomness to determine a recommendation. In still another embodiment, the analyst utilizes a desired stock metric to determine a recommendation. In such an embodiment, one example of a stock metric could be the volatility of the associated stock price, and if the determination is that the price is not volatile enough as compared to a desired level, then the analyst could then recommend and upgrade to the stock, which will in turn lead to more stock trading activity and hopefully a price and volatility increase.

In one embodiment, the known person may affect the share price of their associated virtual shares. In an example of such an embodiment, the known person can increase their share price by maintaining a certain level of activity in relation to the access system, such as by posting updated media content on a regular basis. In another example of such an embodiment, the known person's share price may automatically decrease if they do not maintain at least a minimum level of such access system activity. In this embodiment, it is contemplated that the level of activity can be measured in several ways, such as by looking at the number of updates a known person makes, the types of updates made, the breadth of updates made (e.g. the number of distinct levels that have been provided updated content), the different classes or types of media content posted, the accuracy or timeliness of the media content posted, any combinations thereof or other such ways to distinguish between media content postings.

In one embodiment, the initial share price for a new celebrity is determined based on external factors. In an example of this embodiment, the initial share price is increased for a celebrity who has numerous existing followers on another social media platform, such as Facebook® or Twitter®. In another example, the initial share price is only increased after the celebrity grants the system operator certain access or other permissions to the other social media platform, which may allow the system operator to obtain additional information about both that celebrity and their followers. It is contemplated that other external factors could be utilized to affect the share price, including but not limited to, the celebrity's real-world net worth, the number of products released by the celebrity (e.g., movies, records, etc.), a third party's ranking or classification of the celebrity, the celebrity's rank on a search engine analysis, the occurrence of the celebrity's name in one or more occasions of national media, or any other quantifiable method of discerning one person's popularity from another.

In another embodiment, a celebrity is compensated for their participation in the virtual stock purchases. In another embodiment, a celebrity's compensation is directly tied to the sales and/or performance of their virtual stock. In yet another embodiment, a celebrity will receive additional compensation to participate in the virtual stock purchases. In a further embodiment, a mechanism is provided so that the known person can donate all of or a portion of any compensation they may have received due to any sales of their virtual stock.

In one embodiment, the celebrity receives access to the purchase histories related to their virtual stock, and the underlying demographics related to such purchase histories. In one embodiment, detailed data related to the purchases and sales of virtual stocks are sold to third parties. It is contemplated that this level of detail would provide great value to both the celebrities and their potential employers. It is expressly contemplated that such an access system as described herein can provide invaluable data determined from the purchases of such virtual shares. This information can include demographic information from every purchaser of virtual shares, such as their age, gender, geographic location, salary, profession, working history, purchase history, hobbies, entertainment preferences, their internet surfing history, other virtual share ownership, and any other such information that would provide value in marketing research.

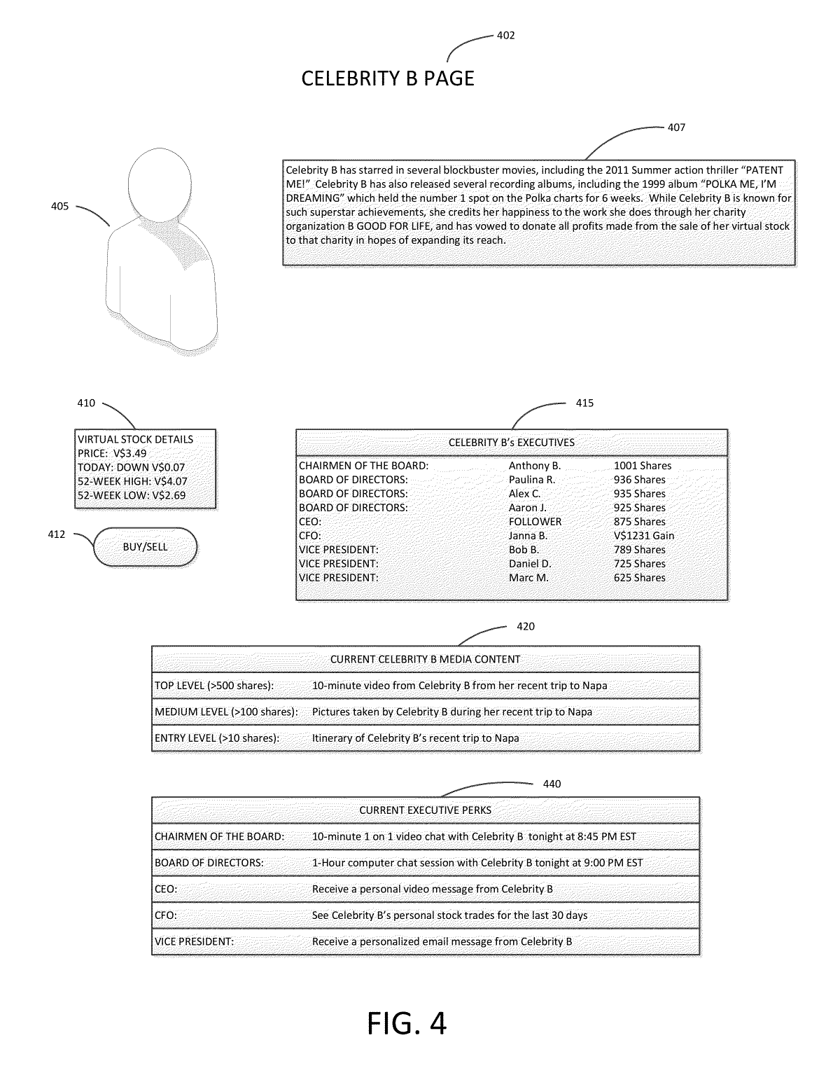

FIG. 4 provides an example of how a celebrity page may be displayed to a user of the system. Specifically, in this example, the Celebrity B Page 402 is caused to be displayed on one of the devices 120, 130 and 140. It is contemplated that this could be a page reached over the internet or other network, and a user may reach this page when researching Celebrity B in an effort to determine whether they should invest in Celebrity B's virtual shares.

In one embodiment, Celebrity B's Page 402 may have some background information of Celebrity B, including an identifying icon 405. The identifying icon 405 could be a photo, a modified photo, an avatar, or just about any symbol that the celebrity or system operator find acceptable to identify the celebrity. In another embodiment, a short description of celebrity B's accomplishments 407 may be included. Again, this field could be populated by Celebrity B, by Celebrity B's employees or agents, or by the operator of the system.

Celebrity B's page 402 may also include, in one embodiment, details related to the virtual shares of Celebrity B 410. In this example, these details include the current price, the daily movement, and the 52-week highs and lows. However, it is contemplated that more or less information could be included here, or could be provided on a separate system page, with a possible link to/from the celebrity page. In one embodiment, a link to buy or sell 412 may be included on the Celebrity B Page 402 in order to allow a visiting follower to act on their research and trade in the virtual shares related to celebrity B. In this example, the buy or sell link 412 would cause the user's device to load a separate page (not shown) which would allow the user to securely trade such virtual shares.

In one embodiment, a list of Celebrity B's Executives 415 may be displayed on Celebrity B's Page 402. Such a listing will identify the various users that have obtained the various positions through their trading of Celebrity B's virtual shares. In the example listing of Celebrity B's Executives 415, only five levels are shown, but again, it is contemplated that the number of levels could be fewer or greater. In this example four of the executive positions (Chairmen of the Board, Board of Directors, CEO, and Vice President) are based on overall shareholdings, while the CFO position is based on overall performance of a user's Celebrity B virtual share portfolio. Again, it is contemplated that there are various ways to establish and identify achievements such as included in the exemplary listing of Celebrity B's Executives 415, and that it is really up to the operator of the access system to determine which ways work best.

The Celebrity B Page 402 could also include a summary of the current Celebrity B Media Content 420. Such a summary is meant to provide information about the various posted media content and their associated different investment levels. In the example shown in FIG. 4, the Top Level of access requires ownership of greater than 500 virtual shares of celebrity B, and such ownership will grant that follower access to a 10-minute video of Celebrity B from her recent trip to Napa. In one embodiment, the more virtual shares that a follower owns, the greater or more prized the access that is provided. In another embodiment, a follower achieving a certain level of access also achieves access to the media content posted for any lower levels. Applying this example to FIG. 4 and specifically the Current Celebrity B Media Content summary 420, that would mean that a follower who owns greater than 500 virtual shares of Celebrity B would have access to the 10-minute video, the pictures, and the itinerary. In one embodiment, the distinction between the qualifications for the various access levels is based on the class of stock purchased or owned by a follower. In a further embodiment, the available media content is changed periodically. In such an embodiment, the period between such changes or updates is preset, random, chosen by the associated known person, chosen by the operator of the access system, a combination thereof, or any other manner as allowed by the access system operator.

Continuing to refer to FIG. 4, a summary of Current Executive Perks 440 could be included in one embodiment of the present invention. In the current example, the summary 440 identifies the various achievement levels (e.g., CEO) and their associated reward (e.g., receiving a personal video message from Celebrity B), and would work to both provide information about the different levels and incentivize other investors to try and reach such achievements. Again, it is to be understood that the summary 440 could have a different title, and could include different titles for the awards, and different rewards. However, it is contemplated that by rewarding users for achieving higher levels of shareholdings, that it will create the incentive to have those users continue their interaction with both the access system and the associated known persons. It is also contemplated that any rewards associated with recognized achievements do not have to be of the personal nature, as presently identified in summary 440, but rather could be additional or different media content similar to what is included in the summary of media content 420.

While one example has been shown at FIG. 4, it is contemplated that additional or different information could be included on such an interface. In one embodiment, the Celebrity's total value can be displayed via such an interface. The Celebrity's total value can be determined many ways, including determining the number of outstanding shares multiplied by their purchase price, the number of outstanding shares multiplied by their current trading price, or simply the current stock price for the known person. In one embodiment, a factor related to the number of unique shareholder is utilized in determining the total value of a celebrity. Such a determination of celebrity value can be utilized to create a competition, and it is contemplated that by creating such a competition amongst the known persons will create additional incentive for the known persons to remain engaged with the access system.

While the applicant has utilized the terms “known person” and “follower” it is contemplated that these terms could be applied to the same person. Specifically, a user could register with the access system to both be a known person, thereby offering virtual shares in themselves, and a follower, thereby having the ability to purchase shares in other known persons. It is further contemplated that a known person, as the term is used herein, may not be a celebrity in the truest sense of the word, but rather is simply a person who wishes to offer, or allow the offer of, virtual shares associated with them. In this embodiment, it is contemplated that some users may desire to become celebrities, and may want to use the access system as a vehicle to assist this desire. Alternatively, some users may simply enjoy letting their friends trade virtual stock in them. Further, as contemplated herein, a known person may not be a person at all, but rather could be a company, product, organization, charity, animal, or even a virtual entity.

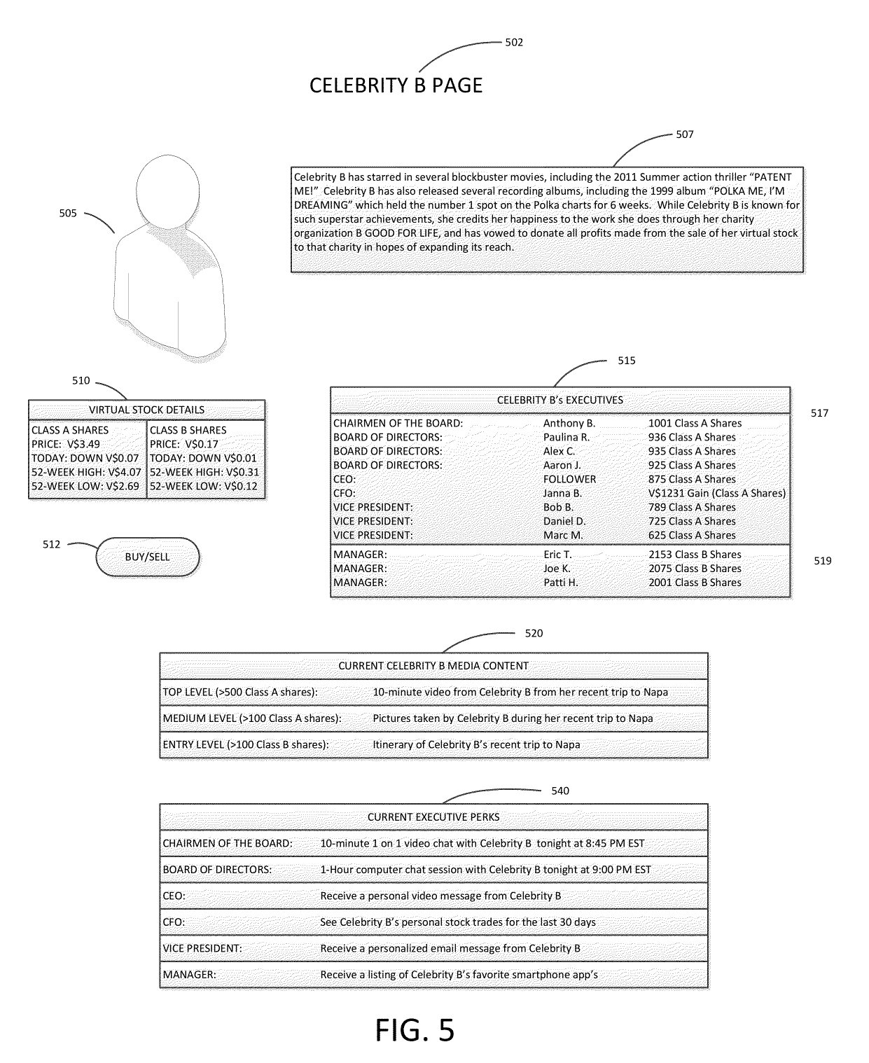

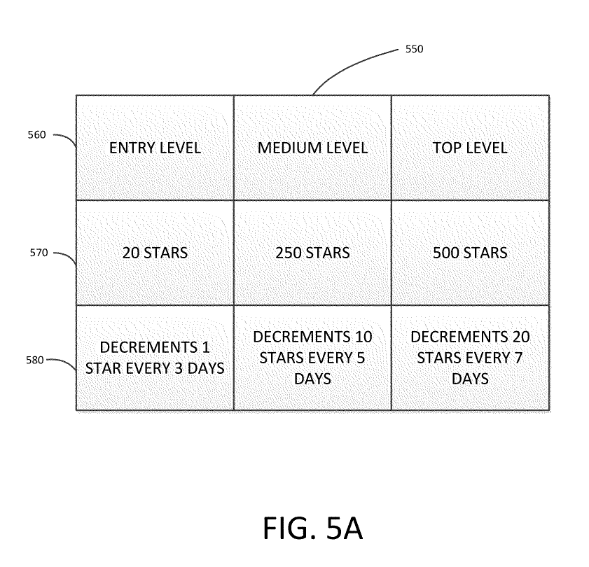

While FIG. 3 and FIG. 4 illustrated example embodiments that included only one type of virtual share, it is contemplated that the operator of the access system could offer various classes of virtual shares. FIG. 5 provides an exemplary interface for a celebrity page where multiple classes of virtual stock are offered. In this example, the interface is designated the Celebrity B Page 502, and in similar fashion to FIG. 4, could include an identifying icon 505 and background information of Celebrity B 507. In the example shown in FIG. 5, two classes of virtual stock are offered for Celebrity B—Class A and Class B virtual shares.

The interface 502 may include details about the virtual shares available for trading 510 as well as a link to buy or sell such virtual shares 512. In this example, Class A shares have a higher cost that the Class B shares, but it is contemplated that the prices could be the same, or could be in different currencies. Offering distinct classes of virtual shares could provide additional avenues for followers to purchase such virtual shares, and would allow the follower to spend a little money in order to gain some access to a known person's media content, or spend more money to gain additional access. It is also contemplated that a user of the access system could purchase and own various classes of shares, and in the current example, could own both Class A and Class B shares of Celebrity B.

The listing of Celebrity B's Executives 515 illustrates the various executive positions available to Class A shareholders 517 and Class B shareholders 519. In this example, the top-level executive positions are only available to Class A shareholders (e.g., CEO), but some executive positions are available to Class B shareholders (e.g., Manager). But as also evident in this example, having a portfolio consisting of a high number of Class B shares is needed in order to gain even minimal recognition as an executive as compared to the number of Class A shares required for the top achievement levels. In one embodiment, separate classes of virtual shares provide access to different media content, and there is no objective class/level of distinction between the different media content. For example, owning Class A shares could provide access to media content related to a known person's favorite travel destinations, but owning Class B shares would provide access to media content related to that known person's favorite dining spots. In this embodiment, the distinction between the various class of virtual shares is based on different subjects of the associated the media content.

Continuing with the example of FIG. 5, the Current Celebrity B Media Content summary 520 distinguishes which levels of general access are available to shareholders based on the class of shares they own. Specifically, a follower must have greater than one hundred Class B shares in order to gain Entry Level status, or must have greater than one hundred Class A shares in order to gain Medium Level status. In one embodiment, a follower having Medium Level status would also gain access to the media content available to those followers have Entry Level status. In another embodiment, a follower must qualify for each level that the follower desires access to the associated media content. It should be noted that in this embodiment, the example summary 520 indicates that a follower qualifying for Top Level status would also qualify for Medium Level status (as having more than 500 Class A shares necessarily means they have more than 100 Class A shares), but not necessarily for Entry Level status. It is apparent that the operator of the access system could configure the access to various media content based on the class of shares owned in various ways without departing from the scope of the invention.

The summary of Current Executive Perks 540 further illustrates the present example where owning Class B shares provides some level of achievement, but not to the extent that owning Class A shares do. Specifically, in this example a Manager is rewarded for achieving that rank with a listing of Celebrity B's favorite smartphone app's, but must purchase a requisite number of Class A shares in order to gain the more desirable access that a Vice President or greater achievement garners.

Providing distinctions between separate virtual share classes can provide many benefits. In one embodiment, one class of virtual shares can only be acquired by purchasing them for true monetary consideration. In another embodiment, some but not each class of shares are available for purchase for V$, with such V$ being able to be acquired without true monetary consideration, such by playing separate contests or participating in promotional contests. In a further embodiment, one class of virtual shares has limitations on a follower selling or trading them to another user, wherein another class of virtual shares does not. In one embodiment, one class of shares has a much more limited number of shares available for purchase as compared to another class of virtual shares, or alternatively, one class of shares simply has a limited number of shares available for purchase wherein another class of virtual shares has an unlimited number of shares for purchase. In still another embodiment, a user must achieve a certain level of accomplishment with one class of virtual stock before they are allowed to purchase another class of virtual stock. In another embodiment, selling one class of virtual stock will only allow the user to purchase new shares of another class of virtual stock. In such an embodiment, a follower may have to use monetary consideration to purchase Class A shares, but upon selling such Class A shares they receive only V$, and V$ can be utilized to purchase Class B shares, but cannot be utilized to purchase Class A shares. In a further embodiment, a factor is applied to the sale of virtual shares of one class in order to provide an increase or decrease to the V$ received for such a sale. An example of such an implementation is where a user purchases a lot of Class A shares for $20 of monetary consideration, which provides a virtual stock worth of V$60, but upon selling such shares, the user receives V$600, but with the restriction that the V$600 can purchase Class B shares, but cannot be used to purchase any Class A shares.

In another embodiment, the system offers distinct classes of virtual dollars, which are each limited in which class of virtual shares they can be utilized to purchase. In an example of such and embodiment, VA$ are needed to purchase Class A shares, and VB$ are needed to purchase Class B shares. In another example, VA$ can only be obtained by exchanging monetary consideration, but VB$ can be obtained through other means, such as selling Class A shares. In one embodiment, one class of virtual dollars can be used to purchase multiple classes of shares, but another class of virtual dollars can only be used to purchase a single class of shares. It is expressly contemplated that the utilization of distinct virtual currencies can drive user desire to purchase or otherwise obtain one or more classes of the virtual currencies.

FIG. 5A provides table 550 which illustrates one embodiment of the present invention which requires additional criterion to be achieved prior to granting access to media content. In this embodiment, a follower must accumulate a prerequisite number of “stars” or “points”, or “star points”, in addition to the required number of virtual share holdings, in order to unlock or otherwise obtain access to the associated celebrity's media content. In one embodiment, the stars are associated with the follower and are not specific to any particular celebrity, and the accumulation by the follower works to unlock the media content for all known person's that the follower owns virtual shares in, but the follower does not spend or otherwise transfer ownership of the stars to obtain such access. In one embodiment, the quantity of stars associated with a follower is displayed on the Follower Page 302. In another embodiment, the stars are provided as rewards for the follower performing certain tasks or satisfying certain criteria. Such tasks or criteria my comprise playing games, participating in surveys, utilizing the access system (e.g. visiting the website), buying and selling virtual shares, buying virtual dollars, accessing 3^{rd} party content or advertisements, performing other tasks, combinations thereof or any other reasonable methods to determine achievements. FIG. 5A illustrates an example of an embodiment, where a follower must accumulate a prerequisite number of stars 570 in order to achieve access to associated levels 560. In this example, 20 stars are required in addition to any virtual shareholding requirements in order to gain access to the entry level media content, or 250 stars for access to the medium level media content, and 500 stars for access to the top level media content. In such an embodiment, the follower is required to both accumulate the preset amount of stars 570, and the preset quantity of virtual shares in order to unlock the respective media content. It is contemplated that a user can accumulate the necessary quantity of virtual shares but not the requisite quantity of stars, or vice-versa, for access to a specified level, and therefore be denied access to that level and have to settle for access to any lower level in which the accumulated totals of stars and shares both satisfy. It is also contemplated that in one embodiment, the required quantity of stars is constant for each known person for the associated level of access, while the required quantity of virtual shares can be different as between different known persons. An example of such embodiment is that while an accumulated total of three hundred stars for a follower is enough to grant access to the Medium Level of Content, as illustrated in FIG. 5A, known person N may have a virtual share requirement of 500 shares for access to his Medium Level Content, while known person M has a virtual share requirement of the top 40% of shareholders for access to her Medium Level Content. It is also contemplated that different levels of known persons could require different levels of stars. For example, top level celebrities may require the level of stars illustrated in table 550, but lower level celebrities may require a lower level of stars for access to each respective level (not shown).

In another embodiment, the quantity of stars or points accumulated by a user will decrease over time. This decrease can be automatic, based on a predetermined algorithm, based on a random determination, based on user activity or inactivity, or any other method that reduces the star totals. In one embodiment, the decrease occurs at predetermined increments of time, such as daily or weekly, or any other measurable unit of time. In another embodiment, the amount of decrease is dependent on the current level in which the accumulated stars are associated with. For example, and again referring to the table 550 of FIG. 5A, decrement levels 580 illustrate that in one example, the higher level that the accumulated total of stars is associated with, the more rapidly the stars will decrement. It is contemplated that in such an embodiment, the decrementing of stars will work to incentivize the associated users to continue their activities in order to maintain or increase their star levels, while also providing a unique way to ensure balance and parity, by providing a mechanism which requires activity to maintain access levels, rather than rely solely on a purely capitalism mechanism where a user can buy the top level of access and block others from obtaining the same or greater access. It is also contemplated that a user could, through his star total being decremented, lose access to specific media content or a level of content without any other user taking any specific actions to unseat that user.

In one embodiment of the present invention, the operator of the access system will implement a digital rights management (DRM) tool in order to limit any subsequent access to the media content which becomes accessible to a user of the access system. In this embodiment, it is recognized that while such an operator would endeavor to limit what a user can do with unlocked media content, in reality there does not exist a perfect DRM tool to protect against all unauthorized uses. However, an operator of the access system may believe that in order to retain the value of the media content in order to drive a desire by the system's users to access such media content, implementing DRM tools is highly desirable. Current DRM tools vary greatly based on the type of media intended to be covered, and it is contemplated that DRM tools will continue to progress as they are constantly being challenged and revised. For example, DRM tools could include, but not be limited to, restrictive license agreements, encryption, scrambling of expressive material, embedding of a tag in the media content, and combinations thereof. In one embodiment, the operator of the access system will not implement any DRM tools.

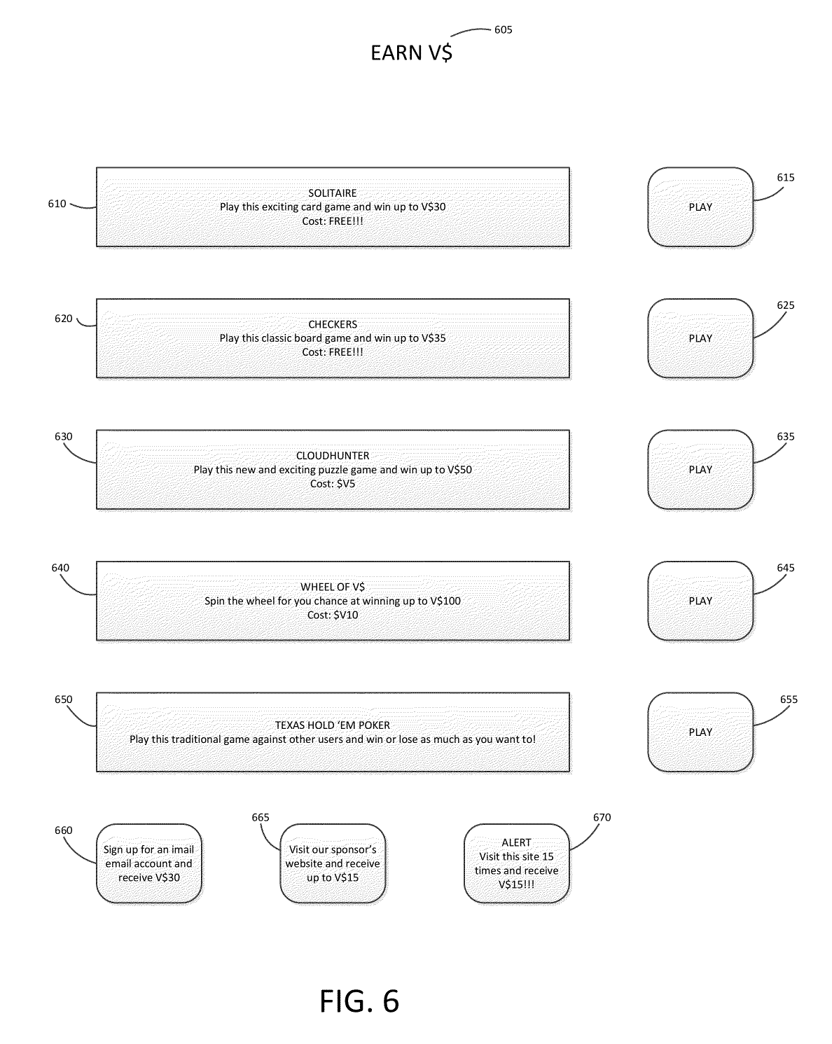

FIG. 6 illustrates an exemplary interface, which might take the form of a website page, to the system for allowing a user of the system to earn additional virtual dollars. Specifically, the Earn V$ interface 605 provides opportunities for a user to earn additional V$ through playing various games or partaking in various opportunities. The first game 610 is solitaire, and provides a user the opportunity to win up to V$30 and has no entry fee to play. If a user desires to play solitaire, they would simply click or otherwise select the associated Play button 615. Alternatively, the second game 620 is a form of checkers, which would provide a chance to win up to V$35 with no entry fee, and a user could select the associated Play button 625 to play. The third game 630 and the fourth game 640 offer different opportunities to a user, and each has a higher potential award but also has and entry fee in order to play, and their associated Play buttons 635 and 645 respectively. The fifth game 650 offers a multiplayer gaming opportunity in the form of traditional Texas Hold 'Em. Such a game gives more flexibility to a user as to how much V$ they can win or lose. And again, if a user wishes to play Texas Hold 'Em, they would, through their device, Play button 655.

In one embodiment, the Earn V$ interface 605 offers additional opportunities, beyond playing of games, for a user to earn V$. For example, opportunity 660 offers a user V$30 if they register for an imail email account. Alternatively, if a user visited a sponsor's website, they may receive up to V$15 per the second opportunity 665. The third opportunity 670 notifies the user that if they continue to visit the access system, they will receive an additional V$15 as a reward for their patronage.

As is evident, there are several ways contemplated to provide users of the access system additional opportunities to earn V$. These additional opportunities could comprise of games of chance, games of pseudo-chance, games of skill, games of pseudo-skill, single player games, multi-player games, marketing promotions, tasked-based rewards, random rewards, rewards based on patronage, rewards based on providing additional information about the user, rewards for taking part in surveys, referral rewards, any combination thereof, and any other manner that an operator deems appropriate to award users additional V$.

In one embodiment, users can earn additional V$ through managing their virtual share portfolio and increasing its virtual net worth. In such an embodiment, awards can be provided to users who manage to increase their virtual portfolio worth. The measurement of increase could be against predetermined levels, or could be relative to other user's virtual portfolios. It is contemplated that in one embodiment, the competition created between users in trying to increase their portfolio values could increase interest by the users to participate in such a virtual stock market game, and increase their desire to keep interfacing with the access system.

Although the foregoing invention has been described in detail by way of illustration and example for purposes of clarity and understanding, it will be recognized that the above described invention may be embodied in numerous other specific variations and embodiments without departing from the spirit or essential characteristics of the invention. Certain changes and modifications may be practiced, and it is understood that the invention is not to be limited by the foregoing details, but rather is to be defined by the scope of the appended claims.

What is claimed is:

1. A computer-implemented method comprising:
associating a known person with an identifying icon;
causing the identifying icon to be displayed on a plurality of remote user video display devices;
associating a number of virtual shares with said know person;
establishing a stock price associated with said number of virtual shares;
causing the established stock price to be displayed on the plurality of remote user video display devices;
receiving a communication from a first user to purchase a first quantity of said number of virtual shares;
communicating to said first user confirmation of their purchase;
receiving a communication from a second user to purchase a second, lesser quantity of said number of virtual shares;
communicating to said second user confirmation of their purchase;
granting to said first user digital rights access to first media content associated with said known person;
granting to said second user digital rights access to different second media content associated with said known person;
denying to said second user digital rights access to said first media content;
modifying the stock price based at least in part on the first user's purchase and the second user's purchase; and
causing the modified stock price to be displayed on the plurality of remote user video display devices.

2. The method of claim 1, further comprising:
receiving a communication from said first user to promise a payment of a currency for said first user's purchase.

3. The method of claim 2, wherein the currency is a virtual currency.

4. The method of claim 3, further comprising:
storing a virtual currency balance associated with said first user; and
causing said virtual currency balance to be displayed on at least one of the plurality of remote user video display devices.

5. The method of claim 3, wherein said virtual currency is based, at least in part, on a monetary currency that was exchanged for at least a portion of said virtual currency.

6. The method of claim 3, wherein said virtual currency is based, at least in part, on an award of virtual currency provided to said first user.

7. The method of claim 1, wherein said first media content comprises a video of said known person.

8. The method of claim 1, further comprising:
causing a monetary benefit to be provided to the known person.

9. The method of claim 1, wherein the modified stock price is greater than the established stock price.

10. The method of claim 1, wherein the digital rights access to first media content granted to the first user is based at least in part on a first star point balance associated with the first user.

11. The method of claim 10, wherein the first star point balance was not reduced when the first quantity of said number of virtual shares was purchased.

12. A computer-implemented method comprising:
receiving an electronic communication from a unique user to establish a known person account;
receiving an electronic communication to associate an icon with the known person account;
establishing a stock price associated with said known person account;
causing the established stock price and the associated icon to be displayed on a plurality of remote user video display devices;
receiving an electronic communication from a first user to purchase a first quantity of said number of virtual shares;
electronically communicating to said first user confirmation of their purchase;
determining a first star point balance associated with the first user;
granting to said first user digital rights access to first media content associated with said known person based at least in part on the first quantity of virtual shares purchased and the first star point balance;
modifying the stock price; and
causing the modified stock price to be displayed on the plurality of remote user video display devices.

13. The method of claim 12, further comprising:
receiving a communication from a second user to purchase a second, lesser quantity of said number of virtual shares;
communicating to said second user confirmation of their purchase;
determining a second star point balance associated with the first user;
granting to said second user digital rights access to different second media content associated with said known person based at least in part on the second quantity of virtual shares purchased and the second star point balance; and
denying to said second user digital rights access to said first media content.

14. The method of claim 13, wherein the second number of virtual shares were purchased at a different share price than the first number of virtual shares were purchased at.

15. The method of claim 12, wherein the first star point balance increased based on the purchase of the first quantity of said number of virtual shares.

16. The method of claim 12, wherein the stock price is modified at least once regardless of any quantity of virtual shares purchased.

17. The method of claim 12, wherein the first media content associated with said know person was uploaded by the known person.

18. The method of claim 12, wherein the first star point balance automatically decrements based on a non-user specified criteria.

19. The method of claim 18, wherein the non-user specified criteria includes at least a determination of the time since the first star point balance was last decremented.

20. A computer-implemented method comprising:
associating a known person with an identifying icon;
causing the identifying icon to be displayed on a plurality of remote user video display devices;
associating a number of virtual shares with said know person;
establishing a stock price associated with said number of virtual shares;
causing the established stock price to be displayed on the plurality of remote user video display devices;
associating a first virtual currency balance and a first star point balance with a first user;
receiving a communication from the first user to purchase a first quantity of said number of virtual shares in exchange for a portion of the first virtual currency balance;
communicating to said first user a confirmation of their purchase and a confirmation of a reduction to the first virtual currency balance;
associating a second virtual currency balance and a second star point balance with a second user;
receiving a communication from the second user to purchase a second, lesser quantity of said number of virtual shares for a portion of the second virtual currency balance;
communicating to said second user a confirmation of their purchase and a confirmation of a reduction to the second virtual currency balance;
determining a first instance of a prior reduction to the first star point balance;
determining a first period of time since the first instance;
when the first star point balance and the first period of time meet a predefined correlation, automatically decrease the first star point balance;
determining a second instance of a prior reduction to the second star point balance;
determining a second period of time since the second instance;
when the second star point balance and the second period of time meet a predefined correlation, automatically decrease the second star point balance;
determining a first access status for said first user based on the first star point balance and the first user's purchase of the first quantity of said number of virtual shares;
determining a second access status for said second user based on the second star point balance and the second user's purchase of the second quantity of said number of virtual shares;
granting to said first user, based on the first access status, digital rights access to first media content associated with said known person;
granting to said second user, based on the second access status, digital rights access to different second media content associated with said known person;
denying to said second user digital rights access to said first media content;
modifying the stock price based at least in part on at least one random factor; and
causing the modified stock price to be displayed on the plurality of remote user video display devices.
